(19) United States
(12) Patent Application Publication
(10) Pub. No.: US 2024/0060751 A1
(43) Pub. Date: Feb. 22, 2024

(54) Camera Holder for Shield

(71) Applicant: United Shield International LLC, Traverse City, MI (US)

(72) Inventor: Brian Banducci, Traverse City, MI (US)

(21) Appl. No.: 18/449,068

(22) Filed: Aug. 14, 2023

Related U.S. Application Data
(60) Provisional application No. 63/398,368, filed on Aug. 16, 2022.

(51) Int. Cl. F41H 5/08; F16M 13/02

(52) U.S. Cl. CPC F41H 5/08; F16M 13/02

(57) ABSTRACT

A camera holder for a ballistic or riot shield has a front layer and a backing layer defining a pocketing. The camera holder is attached to the shield, either fixedly or removably. The camera holder includes attachment material such as hook and loop fastener or adhesive to retainer cabling or the camera itself to the camera holder. In some cases the backing layer comprises a self-reinforced compositing materials that conforms to the curved or radiused surface of the shield. In an example, the camera holder is used to re-mount a chest camera so that its view is not obstructed by the shield.

### CROSS REFERENCE TO RELATED APPLICATIONS

This utility nonprovisional patent application claims the benefit of provisional patent application No. 63/398,368, filed on Aug. 16, 2022, which is incorporated by reference herein.

### BRIEF DESCRIPTION OF THE DRAWINGS

FIG. 1 is a front view of camera holder.

FIG. 2 is a front view of another embodiment of the camera holder.

FIG. 3 is a rear view of the camera holder shown in FIG. 1.

FIG. 4 is a front view of an exemplary shield on which the camera holder shown in FIG. 2 is attached.

FIG. 5 is a front view of an exemplary shield on which the camera holder shown in FIG. 1 is attached.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following description, for the purposes of explanation, numerous specific details are set forth in order to provide a thorough understanding of the invention of the present invention. It will be apparent, however, to one skilled in the art that the invention may be practiced without some of these specific details. Throughout this description, the embodiments and examples shown should be considered as exemplars, rather than as limitations on the invention. That is, the following description provides examples, and the accompanying drawings show various examples for the purposes of illustration. However, these examples should not be construed in a limiting sense as they are merely intended to provide examples of the invention rather than to provide an exhaustive list of all possible implementations of the invention.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

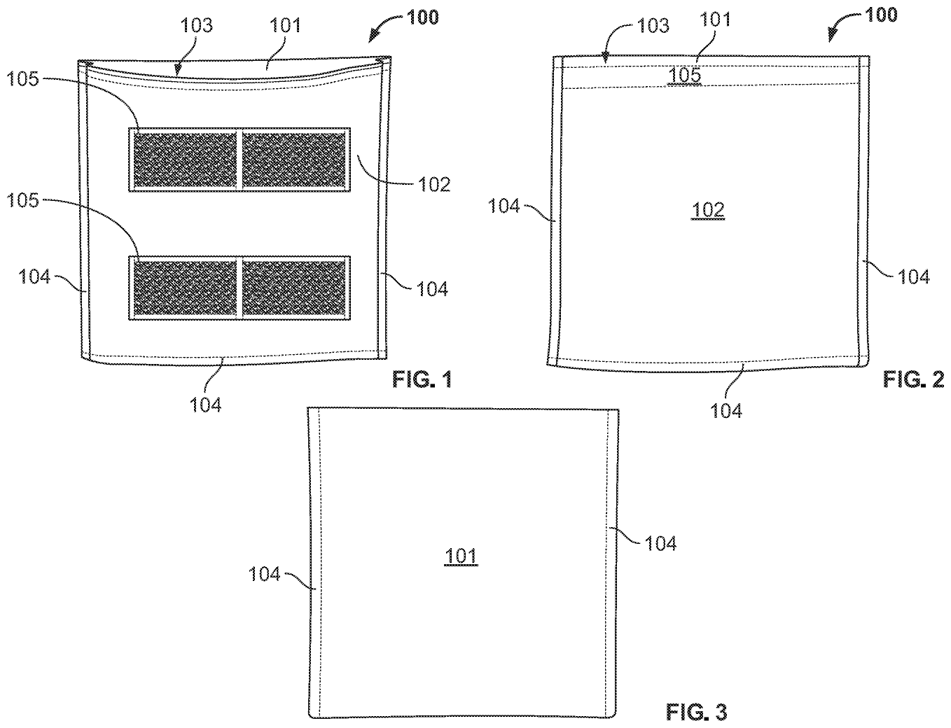

With reference to FIGS. 1-2, shown is an embodiment of the camera holder 100 comprising a one or more layers that are combined to form a mount. For instance, the camera holder 100, as illustrated in FIG. 1, comprises a backing layer 101 and a front layer 102. The front layer 102 is partially attached to the backing layer 101 so as to form a camera mount, such as a pocket or recess 103 between the backing layer 101 and the front layer 102. In some embodiments, the front layer 102 is attached to backing layer 101 along at least one seam line 104, in other embodiments at least two seam lines 104, and yet still in other embodiments at least three seam lines 104 with the front layer 102 is free from the backing layer 101 along a top edge thereof (where 103 points). In some embodiments, the seam lines 104 are constructed such that the front layer 102 is pleated, in order to provide slack and increase the capacity of the pocket or recess 103.

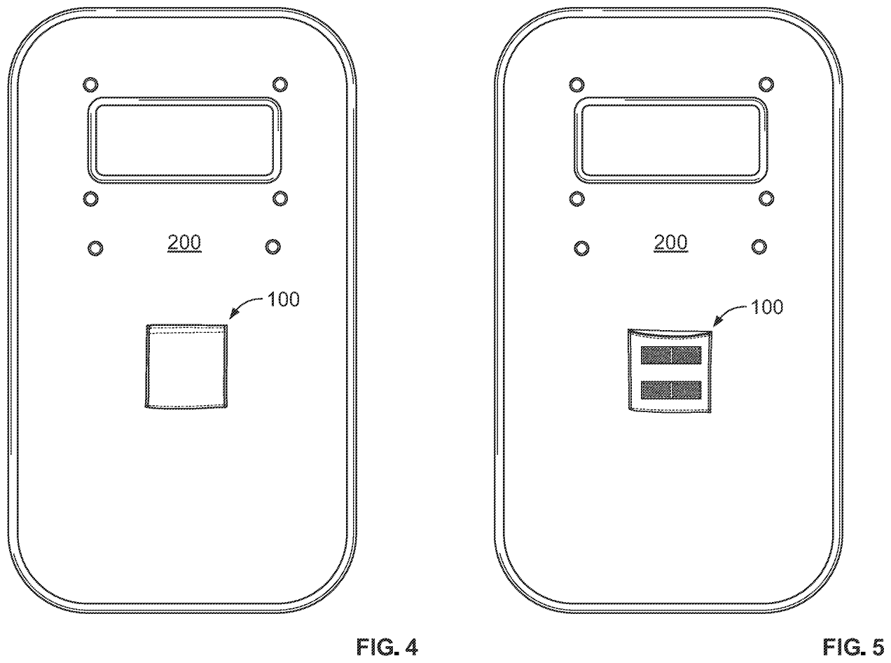

With reference to FIGS. 4-5, the camera holder 100 is configured to be fixed or removably attached to a shield 200 by way of sewing, heat sealing, adhesive, hook and loop fastener, and the like, or in the alternative, the camera holder is integrated to the shield. For example, hook and loop fastener can be provided on the back surface of the backing layer 101 (see FIG. 3, where 101 points). In some embodiments, the shield 200 is configured as a ballistic or riot shield. In this way, the a camera can be removably attached to the camera holder 100 which is affixed to the shield so that the camera can capture activity from the front of the user, without being obstructed. A camera can be inserted into the pocket 103 at least partially and/or clipped or otherwise removably attached to the camera holder 100. The camera holder 100 in some exemplary embodiments may include a magnet that magnetically secures a camera to the camera holder. Alternatively, the camera holder 100 may include a clip onto a slotted web, with the camera holder removably attached, fixed, or integrated to the shield 200, whether that be in the inside or exterior side portion of the shield.

In some embodiments, the front of the camera holder 100 includes hook and loop fastener, adhesive, magnet, clip, or other camera mount or fasteners 105 on the exterior and/or inside the pocket 103 to aid in the retention of cabling or wires extending from an exemplary camera attached to the holder 100. This avoids or minimizes potential tangling that might otherwise occur with the camera power and/or signal cabling, or the camera itself. For example, as shown in FIG. 1, in some embodiments hook and loop fasteners 105 are provided on the outside surface of the front layer 102. In some embodiments, with reference to FIG. 2, a strip of hook and loop fastener 105 is provided along the top edge of the camera holder 105 and is attached about the inside aspect of the pocket 103 so that the otherwise free edge of the pocket 103 can be at least temporarily sealed.

It is appreciated and understood that the components described herein can be of a multi-material construction. In some embodiments, the camera holder 100 is comprised at least partially of Curv® brand thermoplastic self-reinforced composite material with high stiffness and high impact resistance. In some embodiments, the composite material is deformable and/or bendable so as to conform to the typically radiused surface of a ballistic or riot shield. In some embodiments, the backing layer 101 comprises the aforementioned thermoplastic self-reinforced composite materials and the front layer 102 comprises Codura®, such as 500D Codura®.

It is to be noticed that the term “comprising,” used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Put differently, the terms “including”, “comprising” and variations thereof mean “including but not limited to”, unless expressly specified otherwise.

Similarly, it is to be noticed that the term “coupled”, also used in the claims, should not be interpreted as being limitative to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The enumerated listing of items does not imply that any or all of the items are mutually exclusive, unless expressly specified otherwise. The terms “a”, “an” and “the” mean “one or more”, unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A camera holder, comprising:
a camera mount configured to removably receive a camera,
wherein the camera mount of the camera holder is attachable to a surface of a ballistic shield.

2. The camera holder of claim 1, wherein the camera mount comprises a pocket that includes a front layer at least partially attached to a backing layer thereby delimiting a pocket disposed between the front layer and the backing layer.

3. The camera holder of claim 1, wherein the camera mount is fixed to the shield.

4. The camera holder of claim 1, wherein the camera mount is removably attached to the shield.

5. The camera holder of claim 1, wherein the camera mount comprises a front layer that includes a mechanical clip for securing the camera thereon.

6. The cameral holder of claim 1, wherein the camera mount comprises a front layer that includes a magnet for securing the camera thereon.

7. The camera holder of claim 1, wherein the camera mount includes an attachment material layer including any one of a hook and loop fastener or adhesive configured to secure camera cabling or the camera thereon.

8. The camera holder of claim 1, wherein the camera mount is integrated into the ballistic shield.

9. A camera holder and ballistic shield kit, comprising:
a camera mount that includes one or more material layers combined to provide a mount for securing the camera thereon; and
a ballistic shield,
wherein at least one material layer of the one or more material layers of the mount is attachable to a surface of the ballistic shield.

10. The camera holder and ballistic shield kit of claim 9, wherein the mount comprises a front layer at least partially attached to a backing layer delimiting a pocket space disposed between the front layer and the backing layer.

11. The camera holder and ballistic shield kit of claim 9, wherein the pocket space is sized and configured to receive camera cabling or the camera therein.

12. The camera holder and ballistic shield kit of claim 9, wherein the mount includes hook and loop fasteners for securing the camera thereon.

13. The camera holder and ballistic shield kit of claim 9, wherein the mount includes a magnet for securing the camera thereon.

14. The camera holder and ballistic shield kit of claim 9, wherein the mount includes a mechanical clip for securing the camera thereon.

15. The camera holder and ballistic shield kit of claim 9, wherein the mount includes a backing layer that includes a self-reinforced composite material conformed to a radiused surface of the ballistic shield.

16. The camera holder and ballistic shield kit of claim 9, wherein the mount is integrated with the exterior surface of the ballistic shield.

17. A method for attaching a camera to a ballistic shield, comprising the steps of:
providing a camera mount, comprising:
a front layer at least partially attached to a backing layer providing a mount for securing the camera thereon;
providing a ballistic shield that includes the camera mount; and
attaching the camera to the mount.

18. The method of claim 17, wherein the backing layer includes a self-reinforced composite material conformed to a radiused surface of the ballistic shield.

19. The method of claim 17, wherein the mount includes a pocket space for receiving therein the camera or camera cabling.

20. The method of claim 17, wherein the camera mount is attachable to an interior or exterior side of the ballistic shield.
